(19) United States
(12) Patent Application Publication
(10) Pub. No.: US 2007/0291648 A1
(43) Pub. Date: Dec. 20, 2007

(54) VoIP voice quality remote for switch-to-switch connections

(75) Inventors: Gerald W. Pfleging, Batavia, IL (US); George Wilkin, Bolingbrook, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/453,491

(22) Filed: Jun. 15, 2006

(51) Int. Cl. H04L 12/26; H04L 12/66

(52) U.S. Cl. 370/237; 370/352

(57) ABSTRACT

A method to reroute a call with a first and second termination point based upon Quality of Service (QoS) is disclosed. The method comprises establishing a quality of service threshold, connecting a first communication path between the two termination points through the network elements, testing said quality of service along said first communication path and generating a quantitative value based at least in part on said quality of service. The method continues with establishing a second communication path between the network elements if the quantitative value is not up to the level of said quantitative quality of service threshold; and rerouting said data transmission through the newly established second communication path between the network elements while maintaining said termination points.

### RELATED APPLICATION

The application on which this patent is based is related to the commonly-assigned application Ser. No. 11/336,703 filed Jan. 20, 2006, the disclosure of which is incorporated herein by reference.

### BACKGROUND OF THE INVENTION

This invention relates to a method and apparatus for rerouting a data transmission, such as a call. More particularly, this disclosure relates to a method and apparatus for rerouting a call to a different network path based upon quality of service while maintaining both termination points.

While the invention is particularly directed to the art of voice over internet protocol (VoIP) telephony and will be thus described with specific reference thereto, it will be appreciated that the invention may have usefulness in other fields and applications. For example, the invention may be used in other types of audio and data transmission, including, but not limited to, plain old telephone service (POTS), WiFi, Wi-Max, cellular, streaming video, etc. This invention could also be useful in other types of data transfer systems.

By way of background, a VoIP network converts analog audio data to digital audio data. This digital data is then transmitted over the internet as a package stream that represents a call. Many telephone companies use VoIP to streamline networks by routing thousands of phone calls through a circuit switch and into an IP gateway. Among other functions, the gateway compresses the data and transmits the data through the network. Once the package stream associated with a call is received by the designation gateway, the call is decompressed, reassembled and routed to a local circuit switch.

VoIP technology is quickly gaining popularity as a way to transfer voice data. Because of numerous economic and infrastructure benefits, VoIP is quickly becoming a viable alternative to POTS telephone services. However, in order to continue to become a major competitor, VoIP technology must match the level of reliability and voice quality of existing POTS systems.

VoIP technology is often times more sensitive than other forms of data transmission. As such, there are numerous problems associated with VoIP technology, including Quality of Service (QoS) difficulties that are not major factors with other telephone services. Most commonly, excessive bandwidth usage and packets being out of order contribute to poor voice transmission in VoIP. These factors have a very minor impact on data transmission quality so the average customer may not notice the reduction in quality for strict data transmissions. However, the average customer would likely (and indeed does) notice the drop in voice QoS when these difficulties are encountered in VoIP voice services.

In this regard, even when a relatively small amount of packets are lost or are out of order it can cause many noticeable problems such as jitter and latency, which in turn can cause echo problems and/or drop outs. These problems render VoIP technology less desirable to the average user than POTS telephone service.

The telephone service providers have an incentive to meet the high demand of users that desire high level voice quality. Furthermore, telephone service providers typically have access to more than one telecommunications network base. Therefore, there is a need in the industry to reroute calls to different networks giving each data transmission the best opportunity to achieve high quality transmissions. Furthermore, there is a need for a process that can transfer these calls to other network paths automatically with minimal user intervention.

The present invention contemplates a new and improved method and apparatus that resolves the above-referenced difficulties and others.

### SUMMARY OF THE INVENTION

A method and apparatus for rerouting data transmissions that sends the call to different network paths based on quality of service is provided. This disclosure will allow for the transfer of data transmissions to different network bases while maintaining the end points for the users. This method includes a seamless transfer without user intervention.

In one aspect of the disclosure the method includes establishing a quality of service threshold, connecting a first communication path between the first and second transmission points through the first and second network elements, testing the quality of service along the first communications path, generating a quantitative value based on the quality of service, and establishing a second communication path between the first and second network elements for the data transmission if the quantitative value is not up to the level of the quantitative quality of service threshold and rerouting the data transmission through the established second communication path between the first and second network elements while maintaining the termination points.

In accordance with another aspect of the present disclosure, the method further includes rerouting the data transmission from the first communication path to the second communication path while the second communication path is in a different network base than the first communication path.

In accordance with another aspect of the present disclosure, the method further includes rerouting the data transmission in the first communication path to the second communication path while the second communication path is utilizing a different transport type than the first communication path.

In accordance with another aspect of the present disclosure, the method includes generating a report comprising the reasons for rerouting the first communication path.

In accordance with another aspect of the present disclosure, the method further includes testing the quality of service of the second communication path.

In accordance with another aspect of the present disclosure, the method further includes testing an end device associated with the first or second termination point.

In accordance with another aspect of the present disclosure, the method further includes notifying a service provider that the data transmission was rerouted due to quality of service.

In accordance with another aspect of the present disclosure, the method further includes communicating that the data transmission was rerouted to a billing data base.

In accordance with yet another aspect of the present disclosure, the testing of the quality of service along the first communication path is being done continuously.

In accordance with another aspect of the present disclosure, the method further includes that the testing of the quality of service is being conducted using a loop back method.

In accordance with yet another aspect of the present disclosure, the method further includes testing the quality of service by using a bong tone method.

In accordance with yet another aspect of the present disclosure, the method further includes the testing of the quality of service conducted by using an audio logo method.

In accordance with another aspect of the invention, the system includes a quantitative quality of service threshold, a quality of service test module adapted to measure the quality of service and derive a quantitative value for the quality of service, a first and a second network element where the first and second network element has a first communication path set between them and a rerouting module adapted to set up a second communication path between the first and second network element and reroute the data transmission through the second communication path while maintaining the data transmission between the first and second termination points, if the quantitative value for the quality of service of the first communication path is not to the level of the quantitative quality of service threshold.

In another aspect of the present disclosure, the system further includes The first and/or second network element being a gateway.

In another aspect of the present disclosure, the system includes that the first and/or second network elements being switches.

In yet another aspect of the present disclosure the system includes the data transmission being a telephone call.

In accordance with yet another aspect of the present disclosure, the system includes the first communication path being in a different network than the second communication path.

### DESCRIPTION OF THE DRAWINGS

The presently described embodiments exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 illustrates a portion of the communication network including termination points, network elements, communication paths and communication networks.

FIG. 2A illustrates a further detailed embodiment of the communications network of FIG. 1.

FIG. 2B illustrates another embodiment of the communications network in FIG. 1.

FIG. 3 is a flow chart illustrating a method according to the present disclosure.

FIG. 4 illustrates a system module according to an embodiment of the present disclosure.

### DETAILED DESCRIPTION

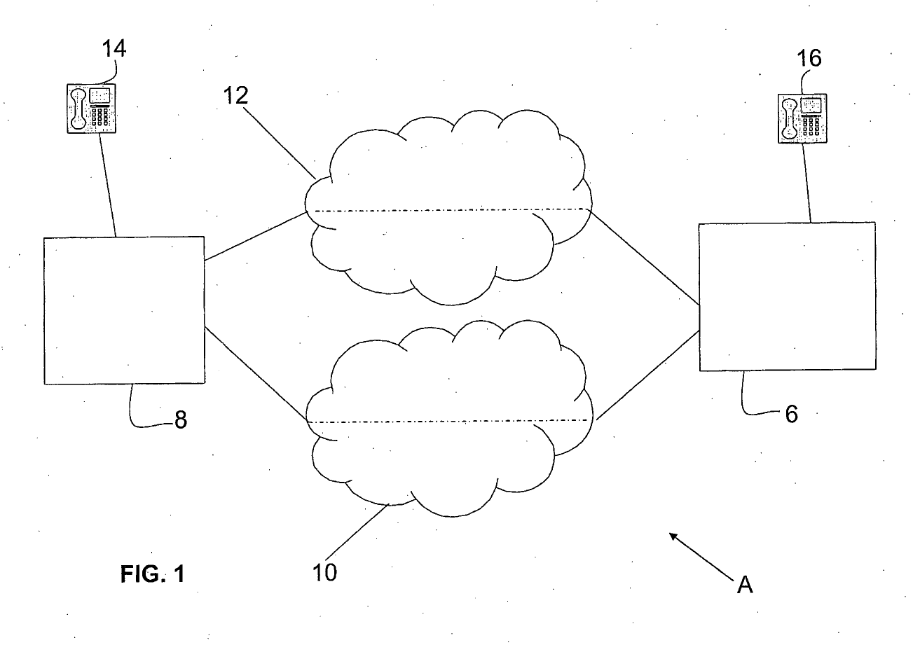

Referring now to the drawings wherein the showings are for purposes of illustrating the disclosed embodiments of the invention only and not for purposes of limiting the same, FIG. 1 provides a view of a system into which the present disclosure may be incorporated, a communications infrastructure A is shown. The communications infrastructure A includes two termination points 14, 16. Two network elements 8, 6 and two communication networks 12, 10. It should be understood that this represents but one embodiment of the communications network infrastructure A. The present disclosure could be incorporated in a variety of communication network configurations.

In operation, as described in greater detail below, the presently described embodiments include a method for rerouting a data transmission, such as a call. The present disclosure allows a data transmission to be rerouted with the trigger being quality of service. If the data transmission fails to meet a minimal quantitative quality of service, the data transmission is rerouted along a different network whereas the new network will carry an improved quality of service. However, the method allows for a smooth handoff between network elements with no intervention from the users. Furthermore, this method allows for the termination points to remain while the handoff is accomplished.

Still referring to FIG. 1, the termination points 14, 16 could be associated with variety of different communication devices, including but not limited to, a wireless telephone, a VoIP telephone, a laptop computer, a desk top computer, a WiFi phone, etc. The end devices are typically the consumer premise equipment (CPE) used to communicate through the compatible line. The termination points 14, 16 are connected to corresponding network elements 8, 6.

A network element may include a switch or a gateway as described in further detail below. The network element acts as a conduit between the end users' devices at the termination points and the communications network 12, 10.

As described in further detail below, the communication networks may also include other network elements, for example, switches, gateways, etc. Examples of possible communication networks include public switch telephone networks (PSTN), cellular networks, VoIP networks, the internet, the intranet, etc.

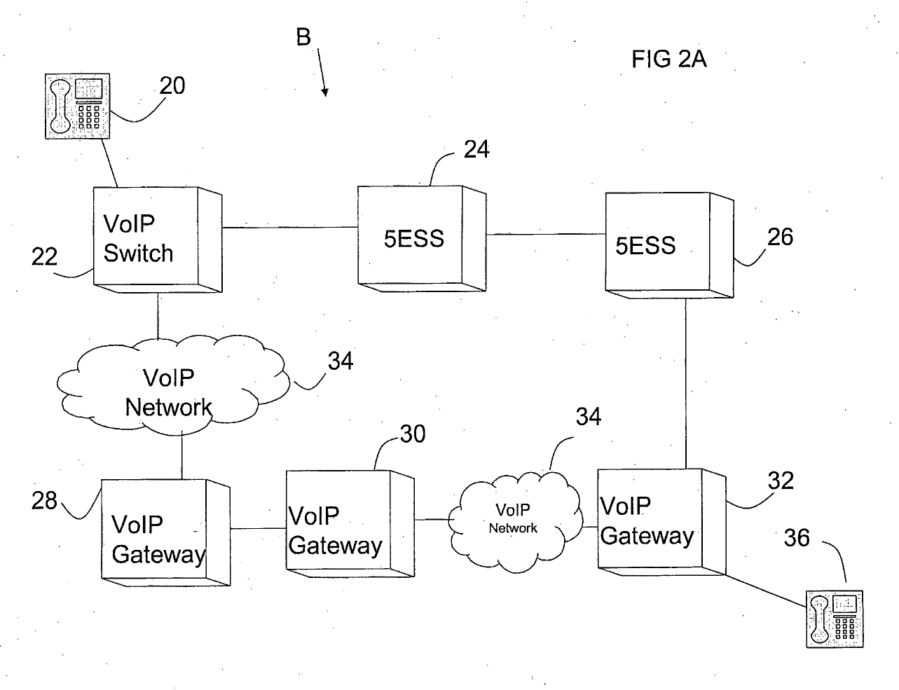

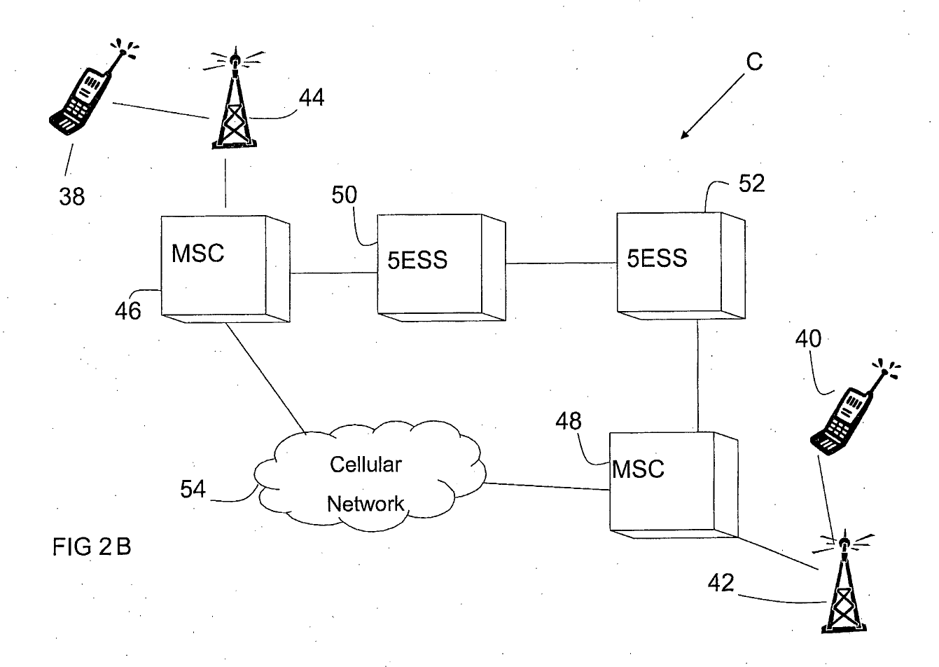

Now referring to FIG. 2A. FIG. 2A illustrates one embodiment of the overall system into which the presently described embodiment may be incorporated. The communications network B is shown generally. The network includes two termination points 14, 16 which are associated with a CPE, a VoIP switch 22, VoIP gateways 28, 30, 32, VoIP network 34 and a traditional circuit switch 24, 26. It should be understood that FIG. 2A represents but one embodiment of the disclosed communication system. Many other communication systems may be substituted and still fit within the scope of the claims.

In this embodiment, a VoIP switch 22 is used to connect the call from one termination point 14 to the network 34. In this embodiment the first communication path is established through the VoIP gateway 22, the VoIP network 34, the next VoIP gateways 28 and 30, eventually to the final VoIP gateway 32 which is connected to the second termination point 16. The second communication path is established through the VoIP switch 22 through the traditional switches 24, 26 and ultimately to the final VoIP gateway 32 which connects to the second termination point 16. Although, this is one embodiment of a first and second communication path, numerous other embodiments may exist. For example, the communication network C, which is illustrated in FIG. 2B.

Referring now to FIG. 2B, a communications network C is shown. In this embodiment, the CPEs associated with the termination points 38, 40 are cellular telephones. In this case, the cellular telephone communicates with a cellular tower 44 which in turn is connected to a mobile switching center 46. The first communication path is through the cellular network 54 back through a MSC 48 and finally to a second communication tower 42 and to the second termination point 40. A second communication path is also shown. The second communication path includes the first MSC 46 connecting to the traditional switches 50 and 52, the second MSC 48. This again is but one embodiment of the communications system and a variety of other communications systems could be substituted and still fit within the spirit of the claims.

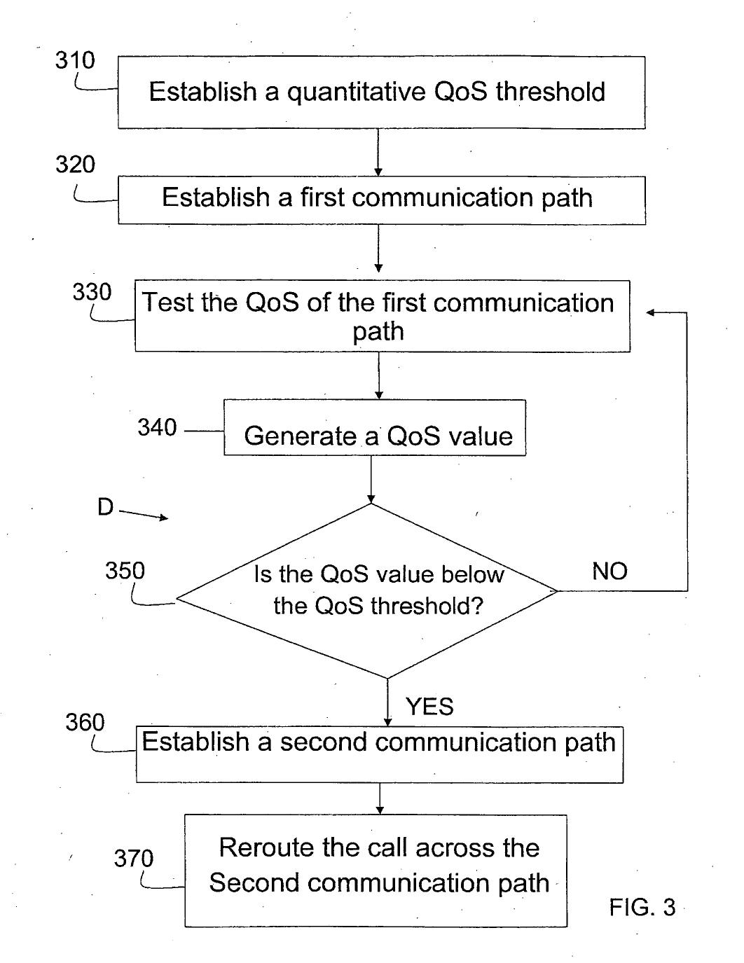

Now referring to FIG. 3, a method of rerouting a call based on quality of service is generally shown at D. It should be understood that the method may be implemented by a variety of software and hardware configurations. In one embodiment, the software implementing the method D resides on a switching or gateway element. In this embodiment, the switch or gateway element communicates with the network provider that the QoS on the call supported by the first communication path is below the minimum acceptable standard. The call is then rerouted through the following method D which is explained in further detail below. It should be understood that suitable software/hardware implementing the embodiments of the invention may also be distributed on appropriate network elements.

The method D includes establishing a quantitative quality of service threshold (at 310). This may be accomplished in a variety of manners known to those skilled in the art. The quantitative QoS threshold will serve to determine what level of quality the network path will tolerate before setting up an alternative communication path in which to carry the data transmission. For example, if there is a demand for high voice quality the QoS threshold may be set very high. If the user has a low demand for voice quality, the QoS threshold may be set very low.

Next, the method D includes establishing a first communication path. As shown in FIG. 2A the first communication path may be through a VoIP network 34. This is but one example. Another example of a first communication network is shown in FIG. 2B as a cellular network 54. Again, a first communication path network could be a variety of different networks, including, but not limited to the internet, the intranet, a PSTN, etc. In the embodiment shown in FIG. 2A, the first communication path would be established through the VoIP network 34.

Next, the QoS in the first communication path is tested (at step 330). This test can be accomplished using a variety of methods. For example, the test can be conducted using a bong tone, audio logo or loop back method as will be appreciated by those skilled in the art. Any suitable test may be conducted provided that the test generates a quantitative value based on the QoS (at step 340).

Many factors may affect the generated QoS value. For example, the VoIP gateway 28 in FIG. 2A may be delivering greatly diminished quality because of excessive band width usage. In addition, the VoIP gateway 28 quality may be diminished because the service provider has a tower down or the line providing the service has been cut. In any form, the quality of service will receive a value reflective of the level of quality. The quantitative QoS value can be determined by Mean Opinion Score (MOS) or any other method that is known in the art.

Furthermore, the network element that is generating the QoS value may get its information from a variety of resources. For example, the VoIP gateway/switch may conduct the test internally, or it could get its information from another gateway or switch 30 or even a CPE 14 that conducted the test.

A determination is then made as to whether the QoS value is below the threshold of acceptable quality (at step 350). In one form the switch and/or gateway 22 may test the quality of the connection during call set up before the call is connected. In another form the testing is conducted during the call. In yet another form, the test is conducted continuously throughout the call. If the QoS value is at or above an acceptable value, the call is maintained and/or connected. If the QoS value is below the minimum satisfactory level, then a second communication path is established (at 360).

In the case where a second communication path is established, the gateway and/or switch may establish this path through a variety of different methods. Referring to both FIG. 2A and 2B, the second communication path is through traditional switches 24 and 26. However, this is not necessarily the case. In one embodiment, the second communication path is the internet. In another embodiment, the second communication path is a VoIP network. In yet another embodiment, the second communication path is another cellular network. It should also be noted that it is not necessary for the first communication path to be a different transport than the second communication path. Furthermore, it should also be noted that a new path need not be established between the network elements nearest the termination points. For example, a second network path could be established from VoIP gateway 22 to the traditional switch 24 and then to VoIP gateway/switch 30 onto VoIP gateway/switch 32 and then to the second termination point 16. In any form, once the second communication path is established, the data transmission is rerouted across that second communication path. In one embodiment, this is a smooth hand off wherein the end users would not be aware that their data transmission indeed switched communication paths. In another embodiment, the second communication path is test in order to ensure that the second communication path has a QoS value above the QoS threshold.

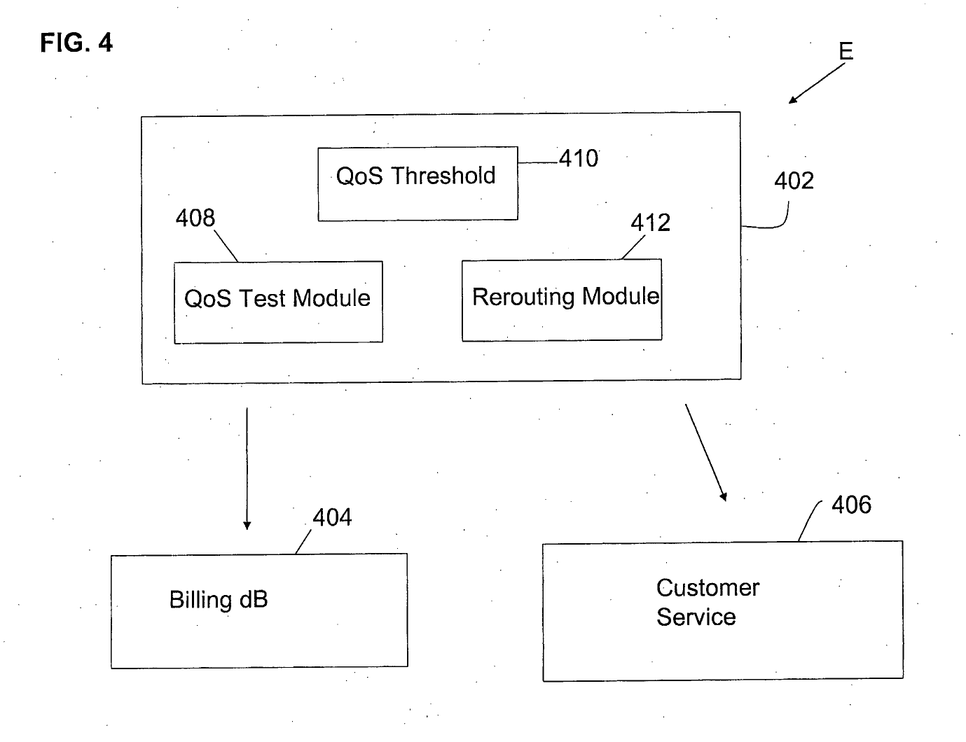

Now referring to FIG. 4, in one embodiment a switch 402 (or switch 22 as in FIG. 2A) houses a testing module 408, a rerouting module 412, a QoS threshold 410 and a connection to a billing data base 404 and customer service 406. It should be appreciated that this is but one embodiment and the above features could be included in a gateway, a CPE, or a plurality of other devices and/or any combination thereof.

The quantitative QoS threshold 410 will serve to determine the level of quality that the network path will tolerate before determining that there is a need to set up an alternative communication path for the data transmission. For example, if there is a demand for very high voice quality, the QoS 312 may be set very high. In the alternative, if the user has a low demand for voice quality, the QoS threshold 410 may be set very low.

The testing module 408 is adapted to measure the QoS of the first path and to derive a quantitative value for the QoS. This can be accomplished by a variety of methods which are known to those skilled in the art. For example, a testing module may be adapted to perform a loop back test, a bong tone test, and/or an audio logo test in which to derive a quantitative score.

The rerouting module 412 is adapted to set up a second communication path if the quantitative value of the QoS of the first communication path does not meet the acceptable level of the QoS threshold 410. Furthermore, the rerouting module is adapted to reroute the data transmission while maintaining both of the termination points. In one form, the rerouting of the call is a smooth hand off wherein the end users are not aware that their data transmission has been rerouted to a different communication path.

The billing data base 404 is where the billing information is stored. The network element may be adapted to communicate with the billing database in the event that a charge for this service may be incurred. For example, a network provider may want to charge a customer a different rate for using a different network. Customer service 406 is where the service provider would collect the information about the network path in order to solve potential problems associated with the customer service.

Another embodiment includes functionality to generate a report as to why the data transmission was rerouted to a second communication path. This report may be generated through trouble shooting in order to find the cause of the than acceptable QoS. This can be accomplished through a variety of methods that are known to those skilled in the art.

Another embodiment includes sending this report to a billing data base 404 and/or the customer service data base 406. In this respect, the service provider could use this information in order to debug the system and improve the voice quality of the service. In addition, the service provider may not choose to bill the end user for use of additional minutes because the network made a decision to reroute the call.

The above description merely provides a disclosure of particular embodiments of the invention and is not intended for the purposes of limiting the same thereto. As such, the disclosure is not limited to only the above-described embodiments. Rather, it is recognized that one skilled in the art could conceive alternative embodiments that fall within the scope of the invention.

We claim:

1. A method to reroute a data transmission, such as a call, having a first termination point, a second termination point, a first network element and a second network element based upon Quality of Service (QoS), said method comprising:
establishing a quality of service threshold;
connecting a first communication path between said first and second termination points through said first and second network elements;
testing said quality of service along said first communication path;
generating a quantitative value based at least in part on said quality of service;
establishing a second communication path between said first and second network element for said data transmission if said quantitative value is not up to the level of said quantitative quality of service threshold; and
rerouting said data transmission through said established second communication path between said first and second network element while maintaining said termination points.

2. The method as set forth in claim 1 further comprising rerouting said data transmission from said first communication path to said second communication path while said second communication path is utilizing a different network than said first communication path.

3. The method as set forth in claim 1 further comprising rerouting said data transmission from said first communication path to said second communication path while said second communication path is utilizing a different transport type than said first communication path.

4. The method as set forth in claim 1 further comprising generating a report comprising the reasons for rerouting said first communication path.

5. The method as set forth in claim 1 further comprising testing the quality of service of said second communication path.

6. The method as set forth in claim 1 further comprising testing an end device associated with said first or second termination point.

7. The method as set forth in claim 1 further comprising notifying a service provider that said data transmission was rerouted due to quality of service.

8. The method as set forth in claim 1 further comprising communicating that said data transmission was rerouted to a billing database.

9. The method as set forth in claim 1 wherein said testing said quality of service along said first communication path is done continuously.

10. The method as set forth in claim 1 wherein said testing said quality of service is conducted by using a loop back method.

11. The method as set forth in claim 1 wherein said testing said quality of service is conducted by using a bong tone method.

12. The method as set forth in claim 1 wherein said testing said quality of service is conducted by using a audio logo method.

13. A system having a first and second termination point that enables a data transmission to be rerouted between said first and second network element comprising:
a quantitative quality of service threshold;
a quality of service test module adapted to measure the quality of service and derive a quantitative value for quality of service;
a first and second network element, said first and second network element having a first communication path set between them; and
a rerouting module adapted to set up a second communication path between said first and second network element and reroute said data transmission through said second communication path while maintaining said data transmission between said first and second termination points if said quantitative value for quality of service of said first communication path is not to the level of said quantitative quality of service threshold.

14. A system as set forth in claim 13 wherein said first or second network element is a gateway.

15. A system as set forth in claim 13 wherein said first or second network element is a switch.

16. A system as set forth in claim 13 wherein said data transmission is a telephone call.

17. A system as set forth in claim 13 wherein said first communication path is in a different network than said second communication path.

18. A system for rerouting a data transmission, such as a call, comprising:
a means for establishing a quality of service threshold;
a means for connecting a first communication path between said first and second termination points through said first and second network elements along;
a means for testing said quality of service along said first communication path;
a means for generating a quantitative value based at least in part on said quality of service;
a means for establishing a second communication path between said first and second network element for said data transmission if said quantitative value is not up to the level of said quantitative quality of service threshold;.and
a means for rerouting said data transmission through said established second communication path between said first and second network element while maintaining said termination points.

19. The system as set forth in claim 18 further comprising a means for rerouting said data transmission through said established second communication path between said first and second network element while said second communication path is in a different network than said first communication path.

20. The system as set forth in claim 18 further comprising a means for rerouting said data transmission through said established second communication path between said first and second network element while said second communication path is in a different transport than said first communication path.
